(19) United States
(12) Patent Application Publication
(10) Pub. No.: US 2003/0000040 A1
(43) Pub. Date: Jan. 2, 2003

(54) Linear motor actuated windshield wiper

(75) Inventors: Miroslav Trajkovic, Ossining, NY (US); Srinivas Gutta, Buchanan, NY (US); David Knapp, Stormville, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/895,115

(22) Filed: Jun. 30, 2001

(51) Int. Cl. B60S 1/06; B60S 1/16; B60S 1/44

(52) U.S. Cl. 15/250.29; 15/250.24; 134/6

(57) ABSTRACT

A windshield wiper is moved across a windshield by a linear motor employing an induction effect. A stator is attached to a vehicle and a driver or truck attached to a wiper blade. Either the stator or driver has coils that are actuated to move the driver across the windshield carrying the blade with it. The blade is swept back and forth with the driver.

### BACKGROUND

Windshield wipers on cars have traditionally been built around a rotational motor/transmission mechanism that is noisy and incapable of providing full coverage of the windshield.

### SUMMARY OF THE INVENTION

A linear motor-based windshield wiper allows a blade to achieve full coverage of a windshield by permitting a wiper blade to be moved across its surface along a line that follows the windshield's shape rather than a center of rotation as in a traditional motor. In an embodiment, coils are embedded within or behind the windshield. Permanent magnets in a truck with a windshield wiper attached thereto are driven by appropriate actuation of the coils to sweep the blade across the windshield. When the wiper is turned off, the truck is controlled to move to one side where a capture mechanism engages it and locks it to the vehicle, thereby preventing theft. The capture mechanism may be mechanical, magnetic, or any other suitable device to preventing theft.

In an alternative embodiment, permanent magnets are embedded in the windshield and coils in the truck actuated to move the truck. In this embodiment, the coils in the truck may be powered by a battery recharged by induction, sliding contacts, etc. The truck may be permitted to move by means of wheels, ball bearings, an air bearing (by injection of air through channels in the windshield, for example), magnetic levitation, by sliding contact, or any other suitable mechanism.

### BRIEF DESCRIPTION OF THE DRAWINGS

FIG. 1 is a figurative (non-scale) illustration of a windshield wiper driven by a linear motor according to an embodiment of the invention where the permanent magnets are located in a truck and coils are attached to the windshield.

FIG. 2 is a section view of a linear motor truck and stator according to an embodiment in which coils are located inside a windshield.

FIG. 3 is a section view of a linear motor truck and stator according to an embodiment in which coils are located within a windshield.

FIG. 4 is a figurative (non-scale) illustration of a windshield wiper driven by a linear motor according to an embodiment of the invention where the permanent magnets are located in the windshield and the coils are attached to the truck and the windshield is held at one end only.

FIG. 5 is a figurative (non-scale) illustration of a windshield wiper driven by a linear motor according to an embodiment of the invention where the permanent magnets are located in the windshield and the coils are attached to the truck and the windshield is held at two ends by separate trucks.

FIG. 6 is an illustration of a control mechanism for operating a windshield wiper driven by a linear motor.

### DETAILED DESCRIPTION OF THE PREFERRED EMBODIMENTS

The following references are hereby incorporated by reference as if fully set forth in their entireties herein: U.S. Pat. Nos. 4,595,870, 5,723,917, 5,519,266. These references describe linear motors and their control mechanisms.

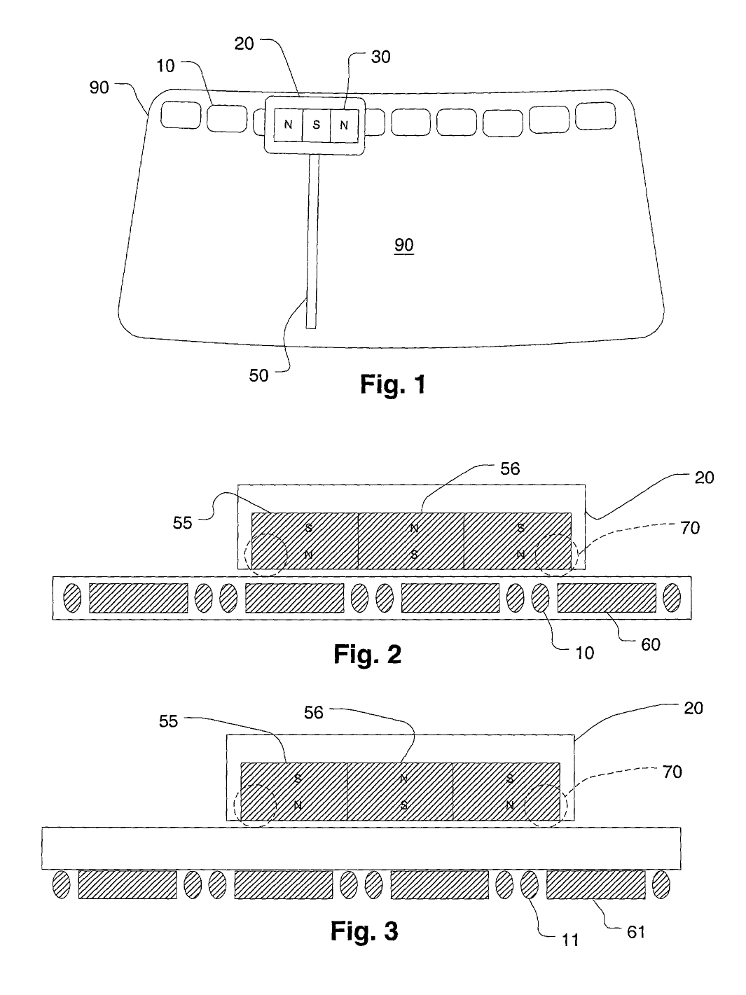

Referring to FIGS. 1, 2, and 3, a windshield 90 is wiped by a wiper 50 driven across the windshield by a linear motor consisting of a truck 20 and multiple coils 10. The coils 10 may be embedded within or behind the windshield 90. The truck 20 rides on wheels 70. Alternatively, the truck may be magnetically levitated, driven over an air cushion, or made to slide in contact with the windshield on a low friction surface, such as a fluorocarbon polymer.

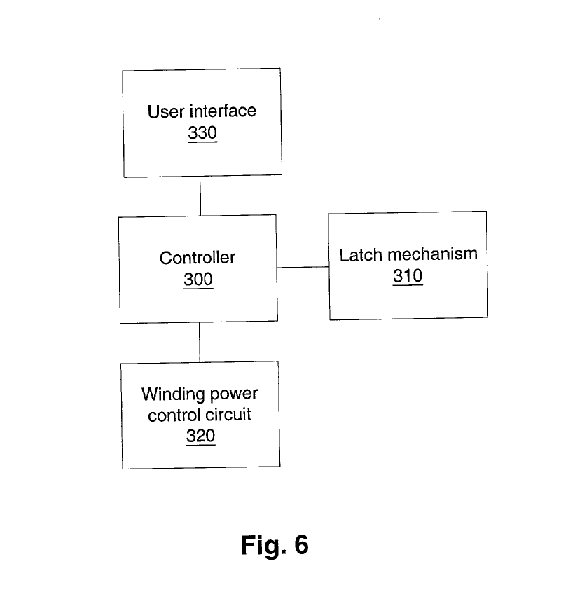

According to well-known principles, magnets 55, 56 are arrayed on the truck 20 with alternating polarity. The coils 10 may or may not have ferromagnetic cores 60 as is also known in the field of linear motors. The coils 10 are shown in section at 11 in FIGS. 2 and 3. A controller (discussed with regard to FIG. 6) controls the linear motor such as to drive the wiper 50 at selected speeds across the windshield 90.

Note that an alternative configuration to that shown in FIG. 1 is to locate the coils within a non-ferromagnetic portion of a vehicle frame. In this way, the coils will not block light. This “stator” could be located below or above the windshield. If located below the windshield, the truck could be completely hidden by a portion of an engine cover as is used to hide, so-called, hideaway windshield wipers on most cars. Note that yet another alternative is to provide multiple wipers and trucks to allow faster clearing of rain for a given linear motor speed.

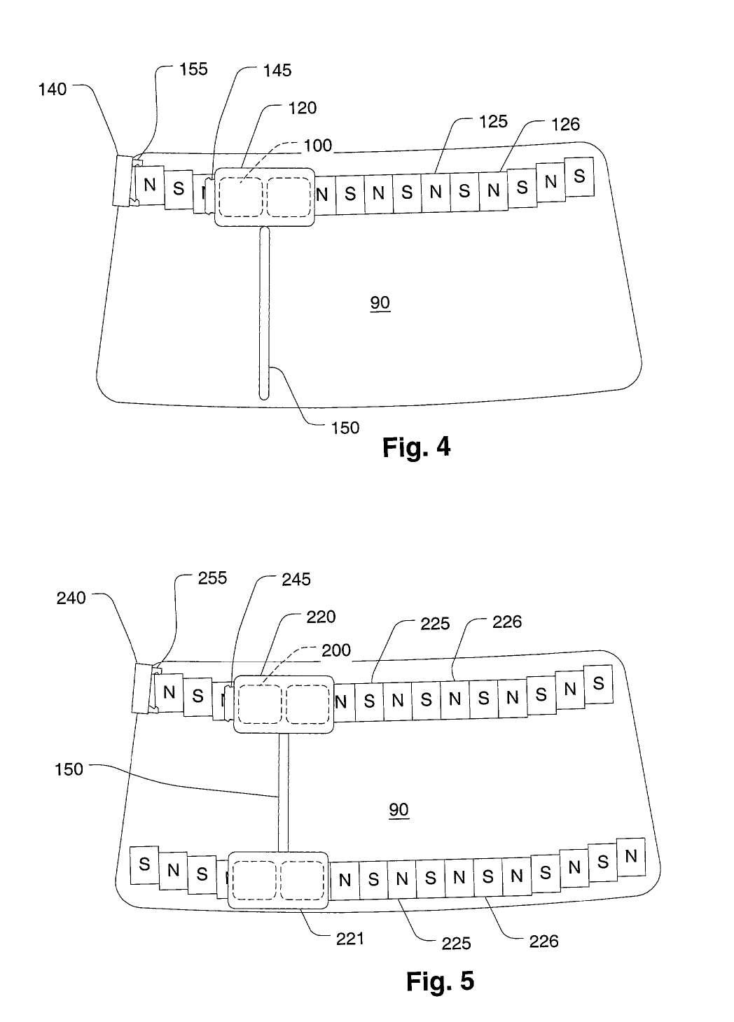

Referring now to FIG. 4, in an alternative embodiment, permanent magnets 125, 126 are provided in the stator (either within or on the windshield 90 as shown or in a portion of the vehicle body). The truck 120 carries the coils 100. The coils 100 may be controlled by a wireless or metallic conductor to convey control signals. The control signals can be from the user interface with a controller on-board the truck or the controller can be in the vehicle with the control signals indicating the current and timing. The coils 100 may have cores or not as indicated with respect to FIGS. 1-3.

The truck in the embodiment of FIG. 4 may receive power from a battery (not shown) in the truck 120 or power may be conveyed through metallic conductors (not shown) through sliding contacts (not shown) in the manner of an electric train. If a battery is used, the battery may be recharged when the truck 120 is in a resting position adjacent a clamp mechanism 140. In the latter case, metallic contacts (not shown) may be used to recharge the truck 120 batteries.

To keep the windshield wiper mechanism from being stolen, the clamp mechanism 140 catches the truck 120 when it is driven to a home position adjacent the clamp mechanism 140. The clamp mechanism 140 may positively engage and prevent release of the truck 120 until an actuator, under control of the controller (not shown here, but shown and discussed with reference to FIG. 6) permits its release. The clamp mechanism 140 has jaws 155 that may be urged by springs inwardly so that a catch 145 can enter between the jaws 155 passively. When the clamp mechanism 140 is activated, it may be toggled to a lock position by an actuator (not shown; the specifics need not be discussed because many alternatives are a routine matter to design) which prevents the jaws from moving apart until the controller again toggles the clamp mechanism 140 to permit the jaws to be moved apart. In this way, power need not be supplied to the clamp mechanism 140 to secure the truck 120 and wiper 150.

Referring now to FIG. 5, a linear motor-driven windshield wiper mechanism has two trucks 220 and 221, one at either end of the wiper 150. The controller controls the two trucks synchronously to maintain the wiper 150 in an alignment suitable for clearing the windshield 90. Note that only one of the trucks 120 is shown with a catch 245 and clamp mechanism 240, but it is clear that both trucks 120 and 121 may be provided with respective such mechanisms.

Referring to FIG. 6, a controller 300 controls the one or more trucks 120, 121 by way of a winding power control circuit 320. The latter may be a power circuit that supplies power directly to windings (coils 10) embedded in the windshield 90 or it may include only control logic (analog or digital) to provide the proper sequencing for driving the current in the coils 100, 200 to move the trucks 120, 220, 221. In the latter case, the winding power control circuit 320 would include a signal transmitter according to whatever scheme is employed to signal the truck 120, 220, 221 coils 100, 200. The controller 300 also controls the latch mechanism 310 to toggle it between its release and capture states. The controller 300 may be a digital controller or an analog controller. The controller receives commands from a user interface 330 which a user employs to turn the system on an off and alter the speed of the wiping action.

What is claimed is:

1. A windshield wiper, comprising:
a first magnetic induction device connected to a windshield wiper blade;
a second magnetic induction device connected to a vehicle;
said first and second magnetic induction devices together forming a linear motor such that said windshield wiper blade may be driven across a windshield when said linear motor is actuated.

2. A wiper as in claim 1, further comprising:
a capture mechanism having a first part attached to said vehicle and a second complementary part attached to said first magnetic induction device;
a controller configured to selectively lock said first and second parts together, whereby theft of said first magnetic induction device and said windshield wiper blade is prevented.

3. A wiper as in claim 1, further comprising a controller configured to control at least one of said first and second magnetic induction devices such that said wiper blade is swept substantially in a linear path.

4. A wiper as in claim 1, further comprising further first and second magnetic induction devices attached, respectively, to said wiper blade and said vehicle and located on opposite sides of said windshield such that said wiper blade is supported at both ends.

5. A wiper as in claim 1, wherein said second magnetic induction device is embedded in said windshield.

6. A wiper as in claim 1, wherein said second magnetic induction device includes an array of permanent magnets and said first magnetic induction device includes battery-powered coils.

7. A windshield wiper driving mechanism, comprising:
a first magnetic induction device connectable to a windshield wiper blade;
a second magnetic induction device connectable to a vehicle;
said first and second magnetic induction devices being such that together they form a linear motor when said second magnetic induction device is attached to a vehicle and said first magnetic induction device is attached to a windshield wiper blade and said windshield wiper blade may be driven across a windshield when said linear motor is actuated.

8. A mechanism as in claim 7, further comprising:
a capture mechanism having a first part attachable to said vehicle and a second complementary part attached to said first magnetic induction device;
a controller configured to selectively lock said first and second parts together, whereby theft of said first magnetic induction device and said windshield wiper blade may be prevented.

9. A mechanism as in claim 8, further comprising a controller configured to control at least one of said first and second magnetic induction devices such that said wiper blade is swept substantially in a linear path.

10. A mechanism as in claim 7, further comprising further first and second magnetic induction devices attachable, respectively, to said wiper blade and said vehicle and locatable on opposite sides of said windshield such that said wiper blade may be supported at both ends.

11. A method of clearing a windshield, comprising the steps of:
moving a device with a wiper blade attached thereto in a substantially linear motion in a first direction across a windshield using a magnetic induction effect to create a traction force along a path of said linear motion;
moving said device in a substantially linear motion in a first direction across a windshield using a magnetic induction effect to create a traction force along a path of said linear motion, whereby a windshield is cleared.

12. A method as in claim 11, further comprising the step of selectively locking said device in a fixed position after said second step of moving.

13. A method as in claim 11, wherein said linear motion follows a slight curve parallel to a curved boundary of said windshield.

14. A method as in claim 11, wherein steps of moving include generating a moving magnetic field.
